(19) United States
(12) Patent Application Publication
(10) Pub. No.: US 2026/0158424 A1
(43) Pub. Date: Jun. 11, 2026

(54) FILTER DEVICE WITH BURST-PROOF FUNCTION

(71) Applicant: PA.E Machinery Industrial Co., Ltd., Taichung City (TW)

(72) Inventor: Ming-Yu Lai, Taichung City (TW)

(73) Assignee: PA.E Machinery Industrial Co., Ltd., Taichung City (TW)

(21) Appl. No.: 19/096,350

(22) Filed: Mar. 31, 2025

(30) Foreign Application Priority Data
Dec. 9, 2024 (TW) 113213548

(51) Int. Cl. B01D 35/30; B01D 35/147

(52) U.S. Cl. CPC B01D 35/30; B01D 35/1475; B01D 2201/16; B01D 2201/20; B01D 2201/302

(57) ABSTRACT

A filter device includes a filter housing, a filter cover that is disposed on the filter housing and that cooperates with the filter housing to define a filter space, and a pressure absorbing unit that includes a flow guiding member disposed on the filter cover, a casing connected to the flow guiding member and defining an accommodating space, a diaphragm disposed in the accommodating space, and an air valve connected to the casing. The flow guiding member defines a flow guiding passage that communicates with the filter space and the accommodating space. The diaphragm divides the accommodating space into a water chamber that communicates with the flow guiding passage, and an air chamber that communicates with the air valve and that is adapted for accommodating compressed gas.

### CROSS-REFERENCE TO RELATED APPLICATION

This application claims priority to Taiwanese Utility Model Patent Application No. 113213548, filed on Dec. 9, 2024, the entire disclosure of which is incorporated by reference herein.

### FIELD

The disclosure relates to a filter device, and more particularly to a filter device with a burst-proof function.

### BACKGROUND

A conventional filter device includes a filter housing, a filter cap that is disposed on the filer housing, and a filter cartridge that is disposed inside the filter housing and that is mounted to the filter cap. The filter cap has a water inlet and a water outlet that communicate with an interior of the filter housing.

When the filter device is put to use, water sequentially flows through the water inlet, the interior of the filter housing, and the water outlet. When a water valve that is located downstream of the filter device is suddenly closed, the water may squeeze surrounding pipes and the filter device due to inertia and low compressibility of the water, so that pressure on the filter device may suddenly increase, which may cause the filter housing and the filter cap to burst eventually.

### SUMMARY

Therefore, an object of the disclosure is to provide a filter device with a burst-proof function that can alleviate at least one of the drawbacks of the prior art.

According to the disclosure, the filter device includes a filter housing, a filter cover that is disposed on the filter housing and that cooperates with the filter housing to define a filter space, and a pressure absorbing unit that includes a flow guiding member disposed on the filter cover, a casing connected to the flow guiding member and defining an accommodating space, a diaphragm disposed in the accommodating space, and an air valve connected to the casing. The flow guiding member defines a flow guiding passage that communicates with the filter space and the accommodating space. The diaphragm divides the accommodating space into a water chamber that communicates with the flow guiding passage, and an air chamber that communicates with the air valve and that is adapted for accommodating compressed gas.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a first embodiment of a filter device with a burst-proof function according to the disclosure.

FIG. 2 is a fragmentary sectional view illustrating that a pressure absorbing unit of the filter device is in an initial state.

FIG. 3 is an exploded perspective view of the pressure absorbing unit.

FIG. 4 is a fragmentary sectional view illustrating that the pressure absorbing unit is in a pressure absorbing state.

FIG. 5 is a fragmentary sectional view illustrating a second embodiment of the filter device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

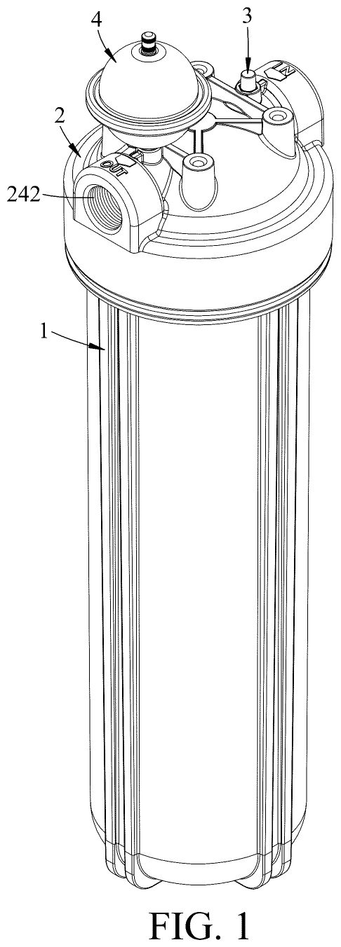

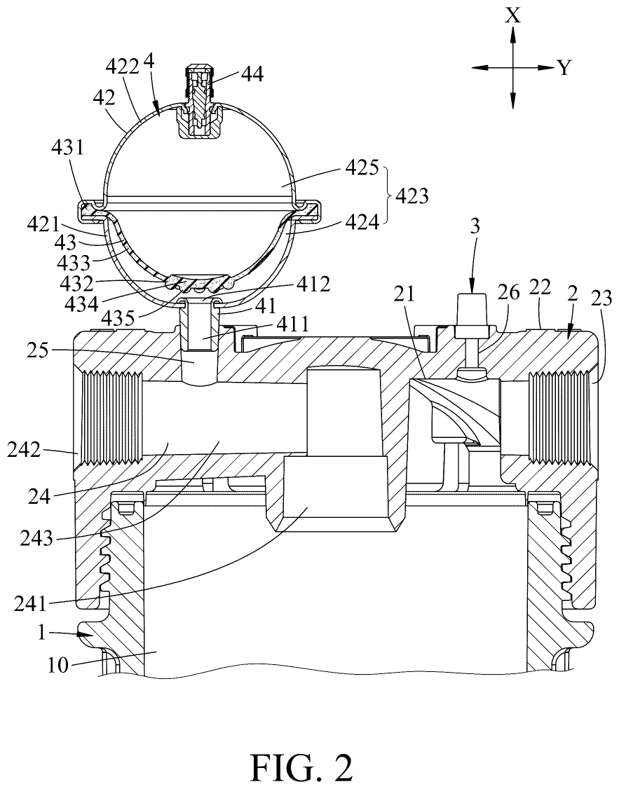

Referring to FIGS. 1 to 2, a first embodiment of a filter device with a burst-proof function according to the disclosure includes a filter housing 1 that extends along an axial direction (X), a filter cover 2 that is disposed at one side of the filter housing 1 along the axial direction (X), a pressure relief valve 3 that is disposed on the filter cover 2, and a pressure absorbing unit 4 that is disposed on the filter cover 2.

The filter cover 2 cooperates with the filter housing 1 to define a filter space 10. The filter cover 2 includes an inner surface 21 that is adjacent to the filter space 10, an outer surface 22 that is opposite to the inner surface 21, a water inlet 23 that extends from the outer surface 22 to the inner surface 21 and that communicates with the filter space 10, an outlet passage 24 that extends from the outer surface 22 to the inner surface 21 and that communicates with the filter space 10, a flow dividing port 25 that extends from the outer surface 22 in the axial direction (X) and that communicates with the outlet passage 24, and a pressure relief passage 26 that extends from the outer surface 22 to the inner surface 21 in the axial direction (X) and that communicates with the filter space 10. The water inlet 23 substantially extends in a radial direction (Y) that is transverse to the axial direction (X). The outlet passage 24 includes a connecting port 241 that extends through the inner surface 21 and that communicates with the filter space 10, a water outlet 242 that extends through the outer surface 22, and a passage portion 243 that substantially extends in the radial direction (Y) and that communicates with the water outlet 242, the connecting port 241, and the flow dividing port 25. The connecting port 241 is adapted for a filter cartridge (not shown) to be installed thereon. The water outlet 242 and the water inlet 23 are opposite to each other in position along the radial direction (Y).

The pressure relief valve 3 is disposed on the pressure relief passage 26 of the filter cover 2. Through the pressure relief valve 3, excess air may be discharged from the filter space 10 so that water in the filter device may flow smoothly.

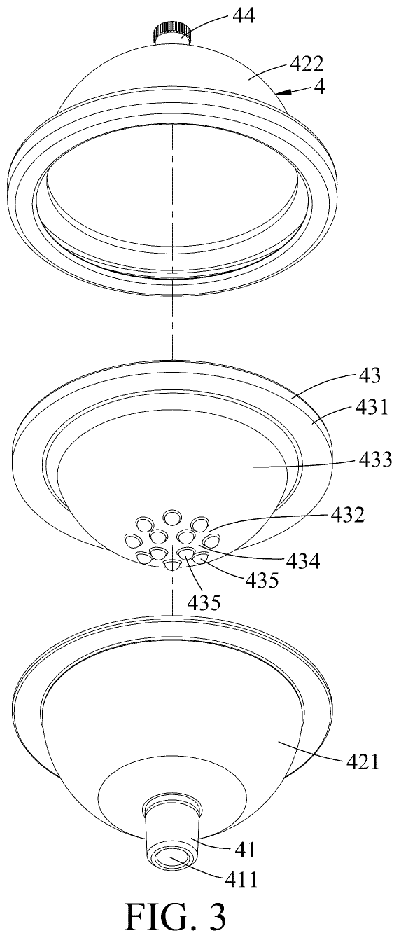

Referring to FIGS. 2 and 3, the pressure absorbing unit 4 is disposed at a side of the filter cover 2 that is opposite to the filter housing 1 along the axial direction (X). The pressure absorbing unit 4 includes a flow guiding member 41 that is connected to the flow dividing port 25 of the filter cover 2, a casing 42 that is connected to the flow guiding member 41 and that defines an accommodating space 423, a diaphragm 43 that is disposed in the accommodating space 423, and an air valve 44 that is connected to the casing 42.

The flow guiding member 41 defines a flow guiding passage 411 that communicates the filter space 10 and the accommodating space 423. Specifically, the flow guiding passage 411 is a through hole and has an opening 412 that is adjacent to and communicates with the accommodating space 423, and one end of the flow guiding passage 411 that is opposite to the opening 412 communicates with the flow dividing port 25. That is to say, the flow guiding passage 411 communicates with the filter space 10 through the flow dividing port 25 and the outlet passage 24.

The casing 42 includes a lower casing portion 421 that is connected to the flow guiding member 41, and an upper casing portion 422 that is connected to the air valve 44 and that cooperates with the lower casing portion 421 to define the accommodating space 423.

The diaphragm 43 is fixed to the casing 42 and divides the accommodating space 423 into a water chamber 424 that communicates with the opening 412 of the flow guiding passage 411, and an air chamber 425 that communicates with the air valve 44 and that is adapted for accommodating compressed gas. Specifically, the diaphragm 43 includes a ring portion 431 that is sandwiched between the lower casing portion 421 and the upper casing portion 422 to be fixed to the casing 42, an anti-blocking structure 432 that faces the opening 412 of the flow guiding passage 411 along the axial direction (X), and a diaphragm body 433 that is connected between the ring portion 431 and the anti-blocking structure 432. In other words, the water chamber 424 is defined by the lower casing portion 421 and the diaphragm 43, and the air chamber 425 is defined by the upper casing portion 422 and the diaphragm 43.

The anti-blocking structure 432 has a body portion 434 that is connected to the diaphragm body 433, and a plurality of protrusions 435 that protrudes from a side of the body portion 434 adjacent to the water chamber 424. The protrusions 435 are spaced apart from each other. A surface of each of the protrusions 435 is curved. Specifically, the diaphragm 43 is made of rubber, and is elastic and ductile. An average thickness of the body portion 434 of the anti-blocking structure 432 is greater than an average thickness of the diaphragm body 433. A width of the body portion 434 is greater than a width of the opening 412 of the flow guiding passage 411. A ratio of the average thickness of the body portion 434 to the width of the opening 412 is greater than 0.2.

The air valve 44 is adapted to inject the compressed gas into the air chamber 425.

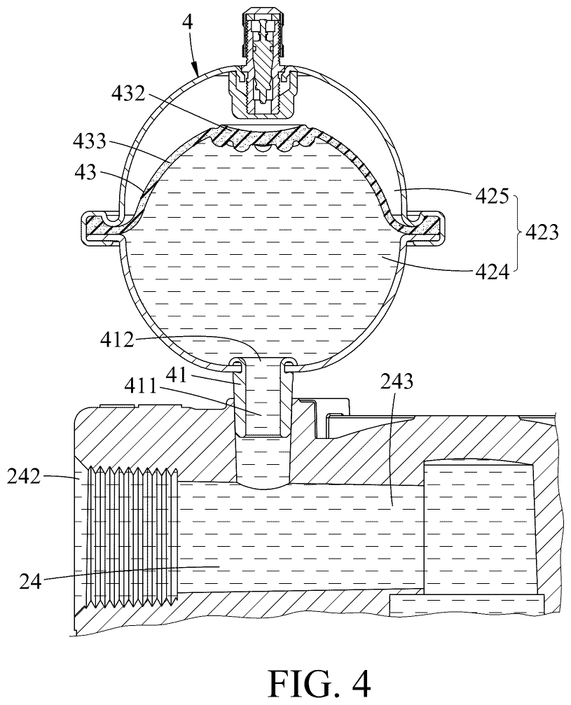

Referring to FIGS. 2 and 4, when the filter device of the disclosure is connected with a water system (not shown), the pressure relief unit 4 may change between an initial state and a pressure absorbing state. When the pressure relief unit 4 is in the initial state (see FIG. 2), water does not flow into the water chamber 424 of the pressure relief unit 4, the compressed gas in the air chamber 425 is expanded and pushes the diaphragm 43 so that the diaphragm 43 is expanded toward the water chamber 424, the air chamber 425 is expanded, and the anti-blocking structure 432 is proximate to the opening 412 of the flow guiding passage 411. At this time, a volume of the water chamber 424 is an initial water chamber volume, and a volume of the air chamber 425 is an initial air chamber volume.

When a water control valve (not shown) that is located downstream of the filter device is suddenly closed so that water flowing through the filter device is suddenly stopped, the water flows into the water chamber 424 and pushes the diaphragm 43 so that the diaphragm 43 is expanded toward the air chamber 425, and the diaphragm 43 is changed into the pressure relief state (FIG. 4). At this time, due to the compressibility of the gas, the volume of the air chamber 425 is changed into a compressed volume that is smaller than the initial air chamber volume, and the volume of the water chamber 424 is changed into an expanded volume that is greater than the initial water chamber volume. Therefore, the pressure on the filter cover 2 and the filter housing 1, caused by the closure of the water control valve, is reduced so as to reduce the risk of rupture of the filter cover 2 and the filter housing 1.

Since the average thickness of the body portion 434 of the anti-blocking structure 432 is related to the average thickness of the diaphragm body 433 and the width of the opening 412 of the flow guiding member 41, when the diaphragm 43 is overly expanded toward the water chamber 424 due to changes in pressure (for example, when the water flows out from the water chamber 424), deformation of the anti-blocking structure 42 is relatively small so that the anti-blocking structure 42 may be prevented from moving into the flow guiding passage 411 and from blocking the flow guiding passage 411. Furthermore, even when the diaphragm 43 is overly expanded toward the water chamber 424 and contacts with the flow guiding member 41 at the opening 412, the protrusions 435 of the anti-blocking structure 432 may be moved the opening 412 and the water may still flow through the opening 412 then enter the flow guiding passage 411, thereby preventing the flow guiding passage 411 from being blocked by the anti-blocking structure 432. Therefore, the anti-blocking structure 432 may ensure normal operation of the pressure relief unit 4.

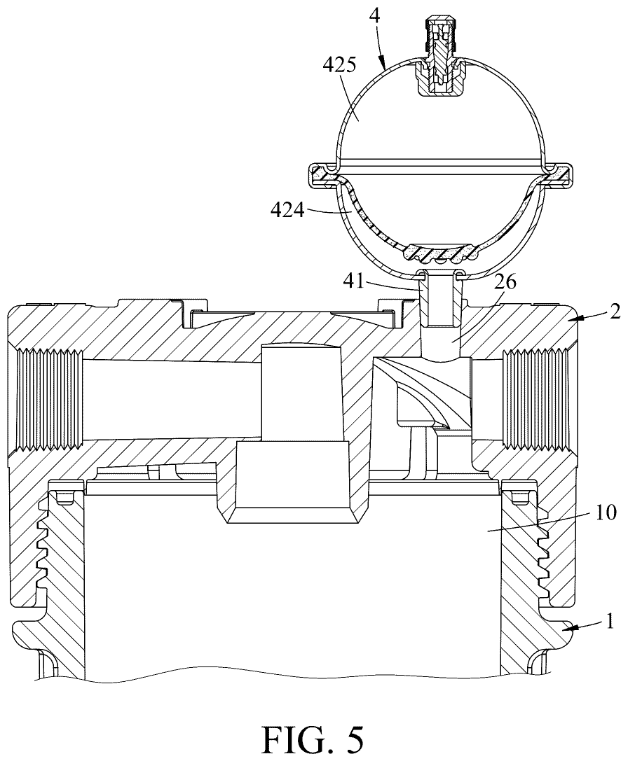

Referring to FIG. 5, a second embodiment of the filter device according to the disclosure is provided. The difference between the second embodiment and the first embodiment is that, in the second embodiment, the flow guiding member 41 of the pressure relief unit 4 is connected to the pressure relief passage 26, and the flow guiding passage 411 of the flow guiding member 41 communicates with the pressure relief passage 26 and the water chamber 424 of the casing 42. Since the flow guiding passage 411 communicates with the filter space 10 through the pressure relief passage 26, the second embodiment of the filter device may also achieve the effect of reducing the pressure on the filter cover 2 and the filter housing 1 when the water control valve is suddenly closed.

In summary, when the flow rate of the water in the filter device of the disclosure is dramatically changed and the pressure of the water in the filter space 10 of the filter device is increased, the water chamber 424 may receive the impact of the water flow and the air chamber 425 may absorb the pressure of the water, thereby reducing the pressure on the water cover 2 and the water housing 1 to reduce the risk of rupture of the filter cover 2 and the filter housing 1. Therefore, the object of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A filter device with a burst-proof function, comprising:
a filter housing;
a filter cover that is disposed on said filter housing and that cooperates with said filter housing to define a filter space; and
a pressure absorbing unit that includes a flow guiding member disposed on said filter cover, a casing connected to said flow guiding member and defining an accommodating space, a diaphragm disposed in said accommodating space, and an air valve connected to said casing, said flow guiding member defining a flow guiding passage that communicates with said filter space and said accommodating space, said diaphragm dividing said accommodating space into a water chamber that communicates with said flow guiding passage, and an air chamber that communicates with said air valve and that is adapted for accommodating compressed gas.

2. The filter device as claimed in claim 1, wherein said filter housing extends along an axial direction, said filter cover being disposed at one side of said filter housing along the axial direction, said pressure absorbing unit being disposed at a side of said filter cover that is opposite to said filter housing along the axial direction, said diaphragm including a ring portion that is fixed to said casing, an anti-blocking structure that faces said flow guiding passage along the axial direction, a diaphragm body that is connected between said ring portion and said anti-blocking structure, said anti-blocking structure having a body portion that is connected to said diaphragm body, and a plurality of protrusions that protrudes from a side of said body portion adjacent to said water chamber.

3. The filter device as claimed in claim 2, wherein said flow guiding passage has an opening that is adjacent to said water chamber, an average thickness of said body portion of said anti-blocking structure being greater than an average thickness of said diaphragm body, a width of said body portion of said anti-blocking structure being greater than a width of said opening of said flow guiding passage.

4. The filter device as claimed in claim 3, wherein a ratio of the average thickness of said body portion of said anti-blocking structure to the width of said opening of said flow guiding passage being greater than 0.2.

5. The filter device as claimed in claim 2, wherein a surface of each of the plurality of protrusions is curved.

6. The filter device as claimed in claim 1, wherein said filter housing extends along an axial direction, said filter cover being disposed at a side of said filter housing along the axial direction, said filter cover including an inner surface that is adjacent to said filter space, an outer surface that is opposite to said inner surface, a water inlet that extends from said outer surface to said inner surface and that communicates with said filter space, an outlet passage that extends from said outer surface to said inner surface and that communicates with said filter space, and a flow dividing port that extends from said outer surface and that communicates with said outlet passage, said outlet passage including a connecting port that extends through said inner surface and that communicates with said filter space, a water outlet that extends through said outer surface, and a passage portion that substantially extends in a radial direction transverse to the axial direction and that communicates with said water outlet, said connecting port, and said flow dividing port, said flow guiding member of said pressure absorbing unit being connected to said flow dividing port, said flow guiding passage of said flow guiding member communicating with said flow dividing port and said water chamber of said casing.

7. The filter device as claimed in claim 6, wherein said filter cover further includes a pressure relief passage that extends from said outer surface to said inner surface and that communicates with said filter space, said filter device further comprising a pressure relief valve that is disposed on said pressure relief passage of said filter cover.

8. The filter device as claimed in claim 6, wherein said water outlet and said water inlet are opposite to each other in position along the radial direction.

9. The filter device as claimed in claim 1, wherein said filter housing extends along an axial direction, said filter cover being disposed at a side of said filter housing along the axial direction, said filter cover including an inner surface that is adjacent to said filter space, an outer surface that is opposite to said inner surface, a water inlet that extends from said outer surface to said inner surface and that communicates with said filter space, an outlet passage that extends from said outer surface to said inner surface and that communicates with said filter space, and a pressure relief passage that extends from said outer surface to said inner surface and that communicates with said filter space, said outlet passage including a connecting port that extends through said inner surface and that communicates with said filter space, a water outlet that extends through said outer surface, and a passage portion that substantially extends in a radial direction transverse to the axial direction and that communicates with said water outlet and said connecting port, said flow guiding member of said pressure absorbing unit being connected to said pressure relief passage, said flow guiding passage of said flow guiding member communicating with said pressure relief passage and said water chamber of said casing.
